(19) United States
(12) Patent Application Publication
(10) Pub. No.: US 2008/0227545 A1
(43) Pub. Date: Sep. 18, 2008

(54) Apparatus and method for digitization of human motion for virtual gaming

(76) Inventors: Nam Chin Cho, Peachtree City, GA (US); Daniel Leland Bragg, Peachtree City, GA (US); Philip Wei Hu, Peachtree City, GA (US)

Correspondence Address: DAN BRAGG, 210 HEARTHSTONE REACH, PEACHTREE CITY, GA, 30269, US

(21) Appl. No.: 11/717,512

(22) Filed: Mar. 14, 2007

(51) Int. Cl. G06F 17/00

(52) U.S. Cl. 463/36

(57) ABSTRACT

Handheld apparatus and method to provide control over virtual figures and elements within a computer rendered environment. Motion capturing sensors output acceleration vector signals. After digitization and storage of these vector signals into data packets, the packets are wirelessly transmitted to the receiver device. The receiver device transfers the digitized packets to a computer or a video game console. A rendering application resident on the console utilizes the received vector data to move the graphical elements on the display. Unique computation of the acceleration vectors result in realistic and real-time human movement in a computer generated three-dimensional environment. Employment of multiple independent handheld apparatuses provides more precise simulation of human motion in a virtual environment.

### FIELD OF THE INVENTION

The present invention relates generally to human motion virtualization, and more specifically to a handheld device operable in free space for controlling virtual human figures or elements within a computerized environment on a display screen.

### BACKGROUND OF THE INVENTION

Typically, a video game controlling device that directs the computer generated figure does not reflect realistic motion of the user. Devices such as a mouse, a joystick, or a keyboard confine the user to a limited two-dimensional space with minimal interactions of the hand or finger(s). A motion capturing system is needed for the user to fully engage with the virtual environment provided by the computer system. However, a typical motion capturing device is used for the purpose of creating computer generated animation films. Such a system is very complex in nature and comprises numerous sensors, wires, cameras, and processing equipments. Therefore it is not suitable in cost, portability, and compatibility for home use. For the application of gaming, a system is needed that encompasses simple, cost effective, and wireless apparatus that captures relative human motion then digitizes the motion vectors so that the computer generated figures can be controlled by the apparatus. Devices within conventional motion capturing systems for gaming are not entirely wireless within free space. The wired architecture of conventional motion capture devices results in the limitation of human interaction with the virtual environment. Generally it is also compatible with only specific graphical console systems, resulting in high end-user cost, and minimal portability. Therefore it is highly desirable to provide a cost effective solution that is easily compatible with a wide variety of gaming/computer systems, yet provides realistic motion translation for gaming as well as interactive exercise routines. Such handheld apparatus must also be completely wireless to deliver unhindered interaction with the rendering system. Also, it must be lightweight, comfortable and safe. The device dimensions, shape and functionality should be optimally designed and proportioned to result in a positive interactive experience for all users regardless of age and size.

### BRIEF SUMMARY OF THE INVENTION

The present invention provides a method and apparatus for controlling virtual human figures and elements on the display of a computer or gaming system. The apparatus of the present invention includes an accelerometer that indicates acceleration vectors in three-dimensional space for each device. Additionally, the apparatus of the present invention includes multiple independent mechanical triggers/switches for additional end user functionality. A microprocessor coupled to the accelerometer digitizes the analog vectors along with trigger/switch engagement data, then efficiently compresses and arranges the data into packets for wireless transmission. In order to eliminate unintentional movements, or hand jitters, the microprocessor utilizes a hysteresis filter in real-time to predict and process current position of the hand. The software distinguishes between low speed human movement and high speed movement to perform multiple motion functions for a single control device. The system filters unintentional human motion due to the inability of the human to remain completely motionless. The system in which the apparatus comprises, includes two wireless RF transmitter devices, and one wired RF receiver device.

### BRIEF DESCRIPTION OF THE DRAWINGS

FIG. 1 is a perspective view of the transmitter device of the present invention.

FIG. 2 is a perspective view of the assembly of the transmitter device of the present invention.

FIG. 3 is a perspective view of the interlocking method of two transmitter devices of the present invention

FIG. 4 is a flowchart illustrating the firmware method of the transmitter device of the present invention.

FIG. 5 is a flowchart illustrating the firmware method of the receiver device of the present invention.

FIG. 6 is a block diagram of a Transmitter device circuit of the present invention.

FIG. 7 is a block diagram of a Receiver device circuit of the present invention.

FIG. 8 is a flowchart illustrating the method of a rendering application of the present invention.

FIG. 9 is a diagram of a typical application of the present invention.

### DETAILED DESCRIPTION OF THE PREFERRED AND ALTERNATIVE EMBODIMENTS

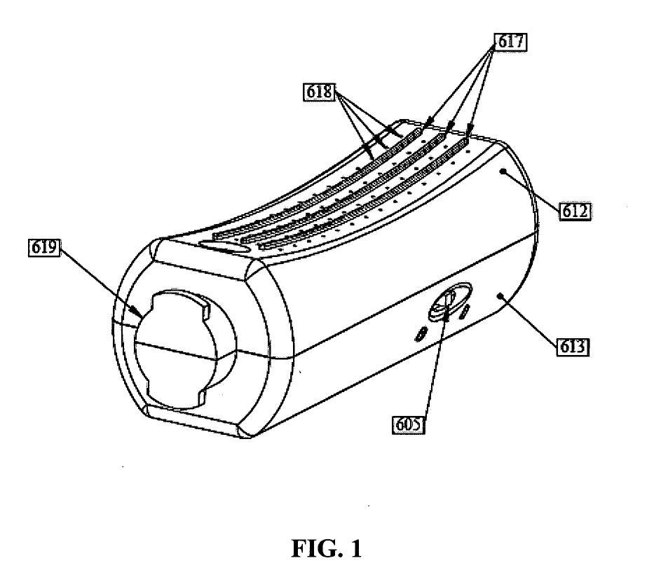

FIG. 1 is a perspective view of the transmitter device. The housing of the transmitter device 612 613 is generally made of plastic. It is specifically shaped and sized to fit comfortably in the average user's hand. The housing consists of push button switches 606 607 located where the user's thumb may generally rest. The push buttons allow the user to select various actions to be executed by the rendering application on the console, in a manner later described herein. The housing of the transmitter device contains an On/Off switch 605 near the middle of the device but does not interfere with user operation. The housing contains raised ribs 617 and ventilation holes 618 generally located in the surface of contact with the user's palm area. These features allow for airflow and minimize contact with the skin, thereby reducing buildup of hand perspiration. In addition, the ribs strengthen the hand grip of the device to reduce potential slippage during use. An interlocking mechanism 619 is located at the bottom of the housing of the transmitter device to permit the interlock of two transmitter devices in order extend the functionality of the overall apparatus.

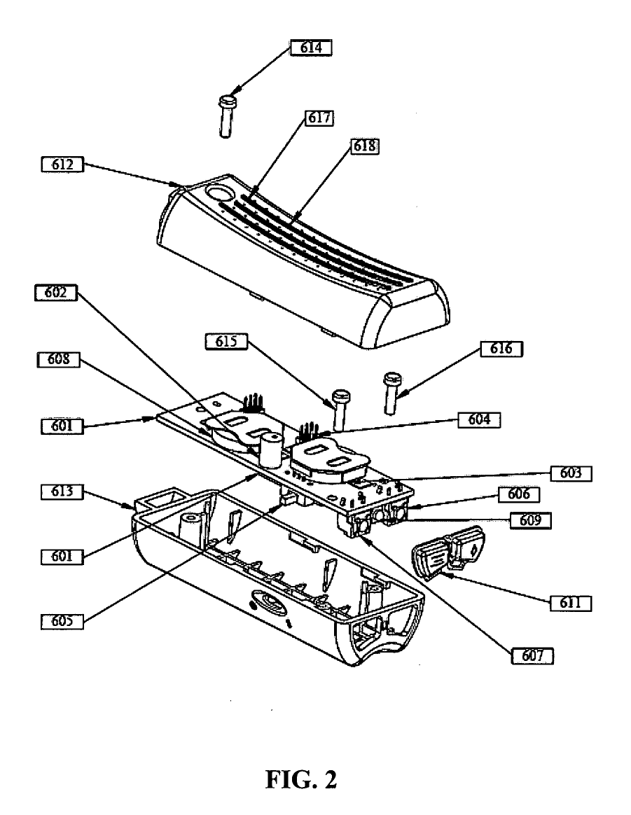

FIG. 2 is a perspective view of the assembly of the transmitter device. A screw 614 connects the top and bottom housing pieces. Two screws 615 616 hold the printed circuit board 601 firmly to the top housing.

The bottom of the printed circuit board consists generally of two coin cell style batteries 608 held in contact with the printed circuit board with coin cell battery holders 603. A capacitor 602 is located in close proximity to the batteries to filter the battery voltage. A six pin programming header 604 allows for programming of the transmitter device microprocessor.

The top of the printed circuit board of the transmitter device consists of two push button switches 606 607 and one On/Off slide switch 605. A LED 609 displays the On/Off status of the transmitter device. Push button switch caps 611 provide a comfortable interface between the user's hand and the push button switches. A microprocessor reads push button presses, accelerometer data and sends data to the transmitter IC for RF transmission. An accelerometer IC translates the acceleration of the user's hand along three axes of motion. The transmitter IC transmits acceleration data to the receiver device via a printed circuit board trace antenna etched on the printed circuit board surface.

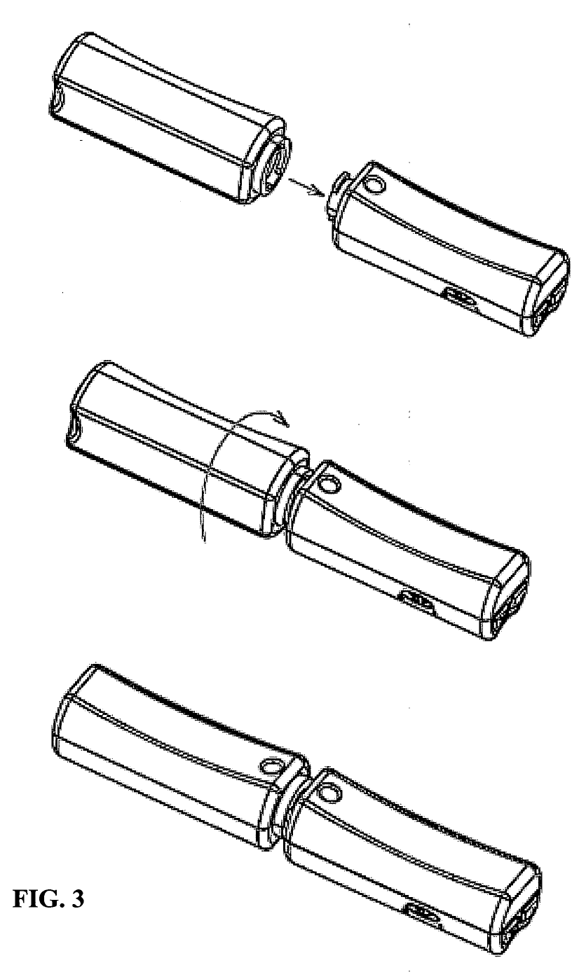

FIG. 3. The transmitter devices of the present invention are generally made with interlocking apparatuses at the base of each device FIG. 1 619. The two transmitter devices when interlocked FIG. 3, provide additional degrees of acceleration signals thereby enhancing human motion translation of specific virtual applications. Virtual applications, such as golf and baseball can take advantage of the additional acceleration signals in replicating real motion.

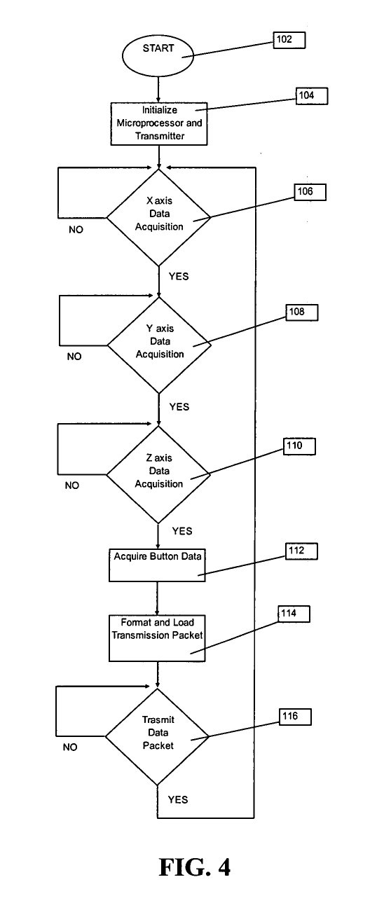

FIG. 4 is a flowchart illustrating the firmware method of the transmitter device. The firmware begins the setup of the hardware configuration of the microprocessor. 104 This is generally accomplished by defining the microprocessor's hardware registers. Specific IO ports are configured to be inputs and outputs. Specific analog to digital converter (ADC) modules are configured for conversion rate. Then the communication ports are generally configured for proper interface timing and interface protocol. Once the initialization is successful, 106 108 110 the microprocessor begins to acquire the acceleration data for the three axes. The ADC module for the specific axis is turned on. The microprocessor uses the ADC to convert the analog voltage signal from the accelerometer into discrete digital acceleration vector values. When the digitization of the acceleration signal is successful, the firmware transitions to the next state to acquire the second acceleration data. However, if the analog to digital conversion is unsuccessful, the firmware steps back to the previous state so that all data within the packet are valid. Upon complete conversion and acquisition of all three acceleration data, the microprocessor stores the current state of the buttons 112 then begins to format the data packet for wireless transmission 114 along with the acceleration data and button data. The microprocessor includes a dynamic time stamp for the receiver device to allow for sample rate calculation by the receiver device. Finally, the microprocessor writes into the transmit buffer of the transmitter IC for the data packet to be transmitted 116. Upon completion of the data packet transmission, the transmitter IC alerts the microprocessor to begin another data acquisition sequence.

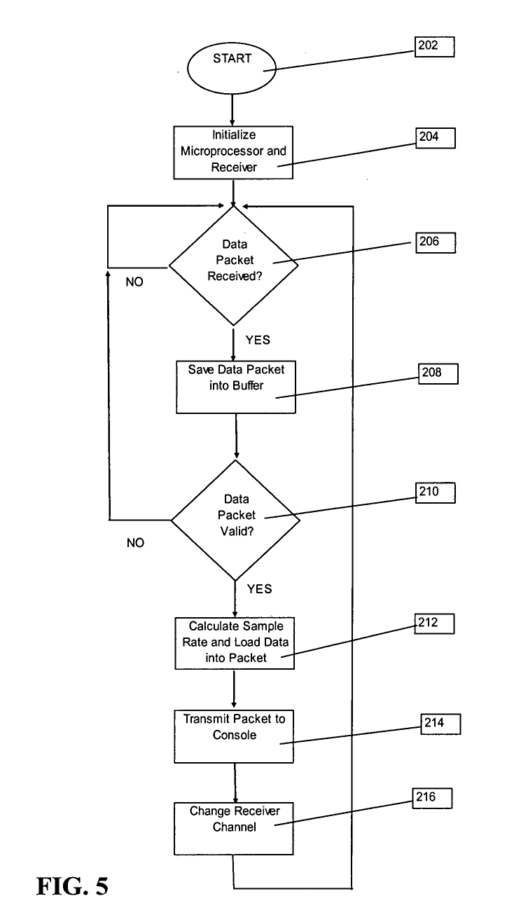

FIG. 5 is a flowchart illustrating the firmware method of the receiver device. The firmware begins the setup of the hardware configuration of the microprocessor 204. This is accomplished by defining the microprocessor's hardware registers. Specific IO ports are configured to be inputs and outputs. Then the communication ports are generally configured for proper interface timing and protocol to communicate with the console. When the initialization of the receiver device is complete, the microprocessor requests the transmitter IC for the status of the received packet 206. If the reception of the data packet is not complete, the microprocessor continues to request for status until a data packet is received. If a data packet is received, it is transferred to the microprocessor's received buffer array for validation of the data. 210 Validation process involves verification of CRC, length checking of the data packet, and verification of the transmitter ID. If any of the aforementioned data fails, the microprocessor rejects the data packet and requests for a new data packet. With a validated data packet, the microprocessor calculates the difference in time between the current data packet and the previous data packet by subtraction of the discrete timestamps 211. This is used as the sample rate of the acceleration. The same procedure is used for the second channel, which carries data packet information for the second transmitter device. When the data packet is filled with new information, it is then transferred serially to the console application 214 via the USB interface. The microprocessor then changes the receiver IC receive channel 216 to the opposing channel.

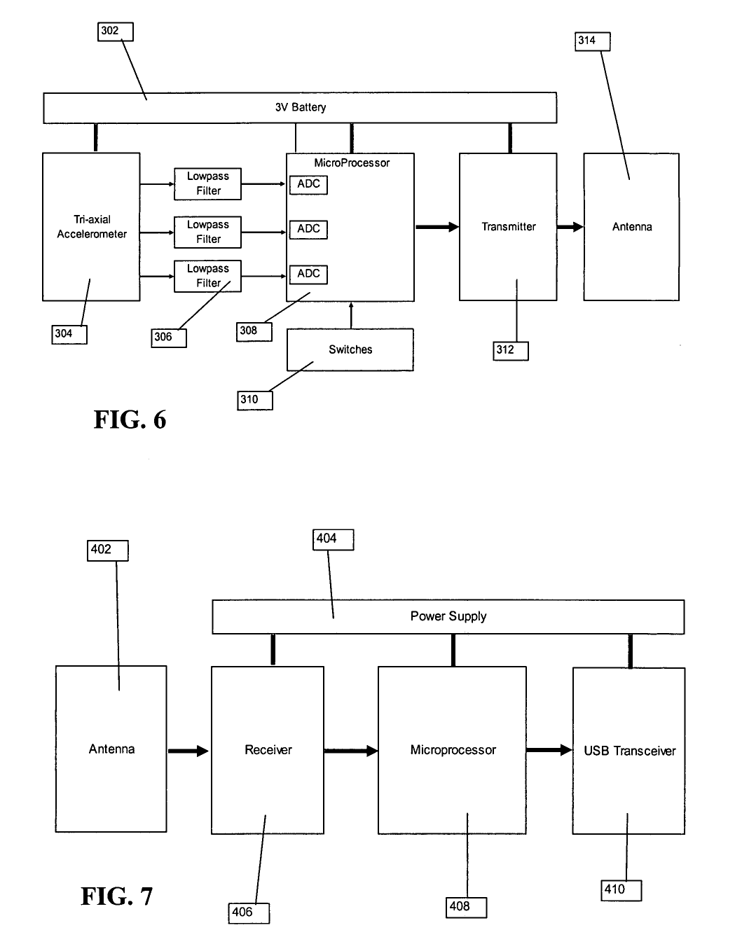

FIG. 6 is a block diagram of a Transmitter device circuit. In order to use a single power source 302, the present invention consists of electrical components that can operate from a common voltage supply. For efficiency of component count that results in optimized cost and enhanced manufacturability, a tri-axial accelerometer 304 is used to provide the human motion data. The acceleration signals first pass through low pass filters 306 so that high frequency noise can be reduced prior to digitization by the microprocessor. Reference voltage of the microprocessor's 308 ADC module is connected to the main power supply so that the fluctuation of the power supply does not affect the analog acceleration signal. Button state is read through the microprocessor's I/O ports 310. The microprocessor passes the formatted data packet 114 to the transmitter IC 312. the transmitter IC transmits the formatted data packets on either channel 1 or channel 2 depending upon microprocessor selection. The onboard printed circuit board antenna radiates the encoded data packet on the selected channel via RF to the receiver device.

FIG. 7 is a block diagram of a Receiver device circuit. The receiver device consists of a power supply 404, antenna 402, RF transceiver IC 406, microprocessor 408, and a serial USB transceiver 410. The receiver device is used to capture the digital data stream from the transmitter devices. The receiver device is capable of switching between multiple RF channels in order to differentiate the incoming data. Incoming data streams can originate from different transmitters that have dedicated acceleration sensing elements. The microprocessor within the receiver device in the present invention determines the validity and origin of the data stream then transfers the data stream to the serial USB transceiver. The serial USB transceiver represents the interface method to the console and console rendering application.

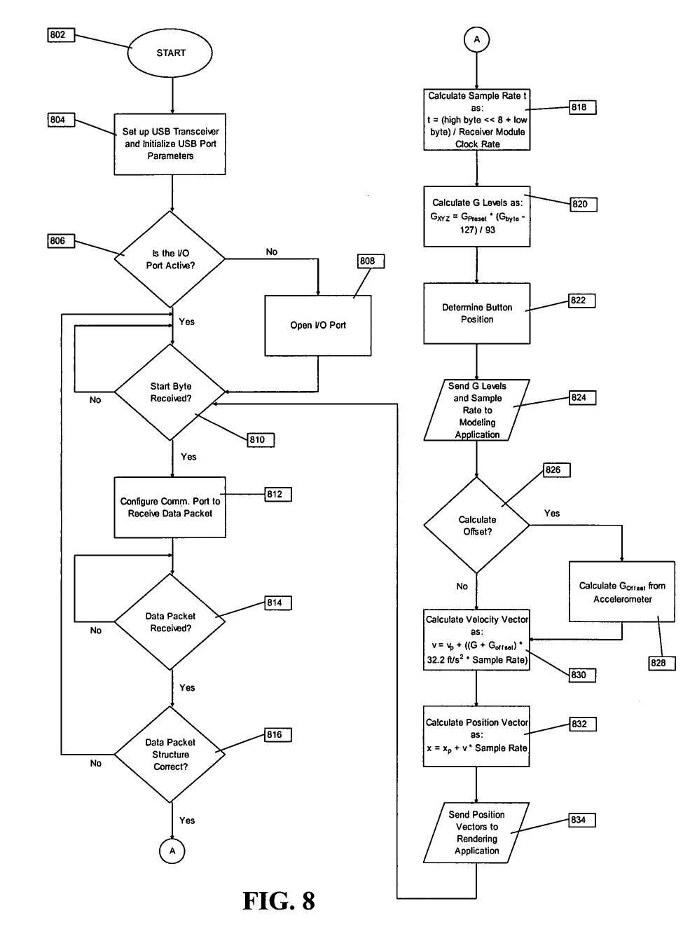

FIG. 8 is a flowchart illustrating the method of a rendering application. Before receiving and decoding motion information the rendering application begins by initializing the computer serial USB transceiver 804 to allow for bidirectional communications between the console rendering application and the serial USB transceiver. The rendering application establishes the communication parameters necessary to logically connect to the USB transceiver device. The rendering application (from here forth simply called the application) detects the open or closed state of the I/O port 806 and opens the port 808 if in the closed state. The application then waits for the receive buffer of the computer to fill with one byte of data 810. On receipt of a data byte the computer determines whether it is one of two possible valid start bytes. Each byte representing the reception from one of two valid transmitter devices. If a valid start byte is not received then the application exits the procedure and returns to waiting for a valid start byte 1005. If a valid start byte is received by the application then the application will set the number of bytes anticipated to eight, set the channel received based on the start byte and exit the procedure 812. Once eight additional data bytes are received the application returns to the procedure to process the data packet 814. After receiving the anticipated data packet of eight bytes, the application then analyzes the final byte (Stop Byte) of the packet to determine if it is a valid data packet 816 for the channel start byte received 810. If the packet is invalid then the application sets the anticipated data size back to 1 byte and returns 810 to receive the start byte. If a valid data packet is received the application calculates the sample rate of the receiver module 818 using data bytes five and six. The application then determines the real acceleration data 820 of each axis X, Y and Z using data bytes one, two and three respectively of the data packet. A determination is made as to the button status 822 (On or Off) of buttons one 606 and two 607 by examining byte four of the data packet and these button states are stored within the application. Sample rate, acceleration data and button state are then sent by the application to the appropriate motion modeling procedure based on the channel received 810. The modeling procedures of the application will calculate an offset value 828 (if requested 826) based on the inherent offset of the accelerometer device. Numerical integration methods (specifically trapezoidal approximation using acceleration and sample rate) are then used to calculate the position vectors as follows. Velocity vectors are calculated for each axis X, Y and Z 830 based on the sample rate 818 and acceleration data and inserted into the position vector calculations. Position vectors are then calculated 832 for each axis X, Y and Z using the previous position data, velocity vector 830 from the previous calculation and the sample rate 818. Position vectors are then sent to the rendering application 834 to animate the human figure. The application then returns control to the serial USB transceiver procedures 810 to receive the next data packet.

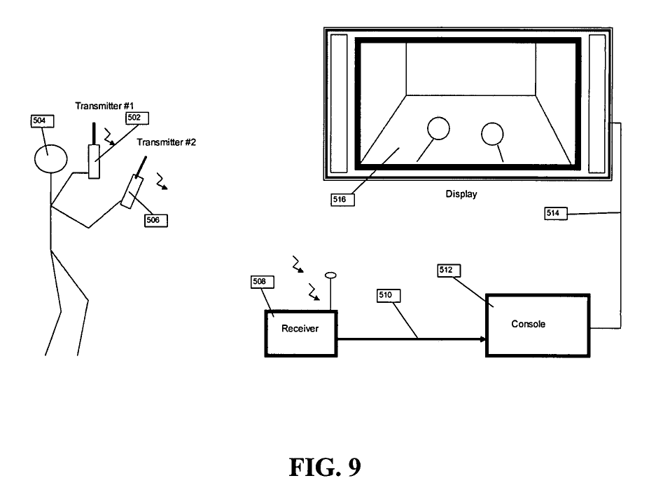

FIG. 9 is a diagram of a typical application of the present invention. The user 504 holds a transmitter device 502 506 in each hand then moves them in free space. The two transmitter devices digitize acceleration with respect to all three axes, and then transmit the signals through a specific wireless protocol. The receiver device 508, upon reception of the data packets from the two transmitters, relays the information to the console 512 via the wired serial USB interface 510. The console, using the acceleration data, renders in its rendering application, appropriate motion of the virtual figures or elements such as a character's hands. The virtual figures are then displayed 514 on a computer monitor or television display.

What is claimed is:

1. A method and apparatus for generating and transferring vector data indicative of direction and acceleration in order to control virtual elements displayed on a computer or gaming console by a graphics rendering system in real time.

2. An apparatus of claim 1, wherein the handheld apparatus includes tri-axial accelerometer element, a microcontroller, and a wireless transmitter packaged for secure and comfortable hand grip.

3. A method of claim 1, wherein each wirelessly transferred data packet contains a relative timestamp for determination of sample rate used for real time processing required to realistically position and orient virtual elements on a console display.

4. A method for translating relative human motion into virtual reality space by way of numerically integrating the accelerometer signals.

5. An apparatus of claim 1 wherein the system utilizes two independent, wireless devices for interactivity with virtual figures on a console display.

6. An apparatus of claim 1 wherein the handheld apparatuses contain an interlocking mechanism to allow for the conjoining of two apparatuses.

7. A method from claim 6 whereby the conjoined apparatuses allow for the generation of two sets of relative acceleration vector signals.

8. An apparatus of claim 1, wherein the handheld apparatus includes ridges to aid in the grip of the apparatus preventing unintended release of the apparatus from the user's hand.

9. An apparatus of claim 1, wherein the handheld apparatus includes holes and ridges in its body to reduce contact surface and increase airflow for the reduction of perspiration buildup between the user's hand and the apparatus body.
